(19) United States
(12) Patent Application Publication
(10) Pub. No.: US 2016/0275493 A1
(43) Pub. Date: Sep. 22, 2016

(54) SECURE ELECTRONIC TRANSACTION FRAMEWORK

(71) Applicant: Microsoft Technology Licensing, LLC, Redmond, WA (US)

(72) Inventors: Ashvin Mathew, Kirkland, WA (US); Yabin Liu, Kirkland, WA (US); Timothy P. Cooper, Redmond, WA (US); Kollen Glynn, New Castle, WA (US)

(21) Appl. No.: 14/806,028

(22) Filed: Jul. 22, 2015

Related U.S. Application Data
(60) Provisional application No. 62/135,331, filed on Mar. 19, 2015.

(51) Int. Cl. G06Q 20/36; G06Q 20/32; G06Q 20/42; G06Q 20/40

(52) U.S. Cl. CPC G06Q 20/3674; G06Q 20/401; G06Q 20/327; G06Q 20/42; G06Q 2220/00

(57) ABSTRACT

A transaction security and authentication system comprises, in one example, a front-end transaction system interface component configured to communicate with a front-end transaction system that performs a transaction with a user, a client device interface component configured to communicate with a client device of the user, and a transaction security component configured to receive a transaction request, for the transaction, from the front-end transaction system, the transaction request including a unique transaction instrument identifier, and authenticate the transaction by sending a transaction confirmation request to the client device based on the unique transaction instrument identifier and receiving a transaction confirmation from the client device.

### CROSS-REFERENCE TO RELATED APPLICATION

The present application is based on and claims the benefit of U.S. provisional patent application Ser. No. 62/135,331, filed Mar. 19, 2015, the content of which is hereby incorporated by reference in its entirety.

### BACKGROUND

Computing systems are currently in wide use. Some such computing systems are utilized by retail organizations. For example, a computing system can be deployed at a point-of-sale (POS) for a brick and mortar retail store, or in other environments such as kiosks and call centers. In another example, an organization may have an online storefront (or web store front). Such computing systems can be utilized to support consumer transactions through a variety of different value transfer methods.

The discussion above is merely provided for general background information and is not intended to be used as an aid in determining the scope of the claimed subject matter.

### SUMMARY

A transaction security and authentication system comprises, in one example, a front-end transaction system interface component configured to communicate with a front-end transaction system that performs a transaction with a user, a client device interface component configured to communicate with a client device of the user, and a transaction security component configured to receive a transaction request, for the transaction, from the front-end transaction system, the transaction request including a unique transaction instrument identifier, and authenticate the transaction by sending a transaction confirmation request to the client device based on the unique transaction instrument identifier and receiving a transaction confirmation from the client device.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a secure electronic transaction architecture.

FIG. 2 is a block diagram of one example of a transaction agent.

FIG. 3 is a block diagram of one example of a client agent.

FIG. 4 is a block diagram of one example of a transaction security and authentication system.

FIG. 5 is a flow diagram of one example of a method for registration of a transaction instrument and client device(s).

FIG. 6 illustrates one example of a registration record.

FIGS. 7-1 and 7-2 show a flow diagram of one example of a method for processing a transaction using a transaction instrument registered with a transaction security and authentication system.

FIG. 8 is a block diagram showing one example of the architecture illustrated in FIG. 1, deployed in a cloud computing architecture.

FIG. 9-11 show various examples of mobile devices that can be used in the architectures discussed in the previous figures.

FIG. 12 is a block diagram of one example of a computing environment that can be used in various parts of the architectures set out in the previous figures.

### DETAILED DESCRIPTION

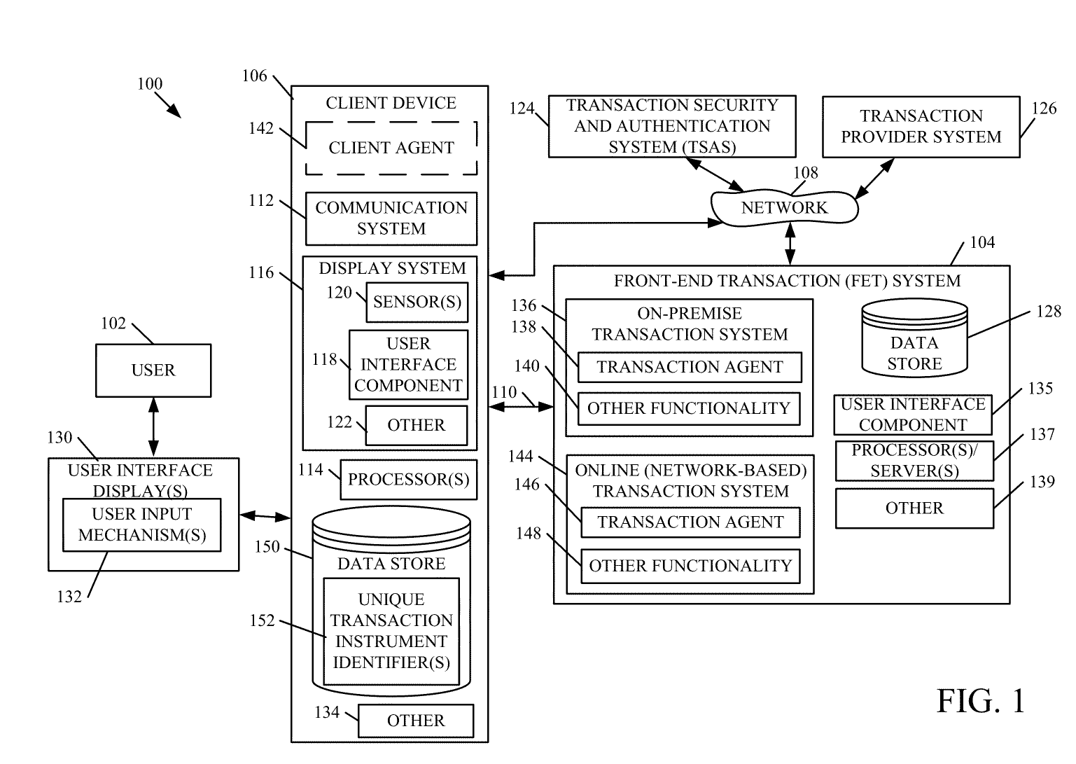

FIG. 1 is a block diagram of one example of a secure electronic transaction architecture 100 which provides a framework for facilitating secure transactions between a user 102 and a front-end transaction (FET) system 104. System 104, in one example, is used by an organization (e.g., a merchant or other retail organization) to initiate and perform a transaction involving a value transfer. A value transfer can include a transfer of electronic funds for a transaction, such as a payment to an organization for goods or services that are provided by the organization. For the sake of the present discussion, payment will be used to refer to a value transfer including, but not limited to, a transfer of funds or other item of value from one entity to another, for example in exchange for the provision of goods, services, and/or to fulfill an obligation.

User 102 illustratively uses a client device 106 to communicate with system 104. For example, client device 106 can communicate with system 104 through a network 108, such as a wide area network (e.g., the Internet). Alternatively, or in addition, client device 106 can communicate with system 104 directly, as indicated by reference numeral 110.

While FIG. 1 illustrates a single user 102 using a respective client device to access systems 104 and 124, any number of users can interact with architecture 100. Each of the users can access components of architecture 100 locally and/or remotely. Further, the user input mechanisms 132 sense physical activities, for example by generating user interface displays that are used to sense user interaction with architecture 100. The user interface displays can include user input mechanisms that sense user inputs in a wide variety of different ways, such as point and click devices (e.g., a computer mouse or track ball), a keyboard (either virtual or hardware), a keypad, where the display device used to display the user interface displays a touch sensitive display, the inputs can be provided as touch gestures. Similarly, the user inputs can illustratively be provided by voice inputs or other natural user interface input mechanisms as well.

Client device 106 can be any of a variety of different types of device. For example, client device 106 can comprise a desktop computer, a laptop computer, a tablet computer, or other mobile device, such as a palm top computer, a smart phone, a non-smart phone (i.e., feature phone), a multimedia player, a personal digital assistant (PDA), et cetera.

Client device 106 includes a communication system 112 for communicating through wired and/or wireless interfaces. As illustrated in FIG. 1, communication system 112 is configured to communicate with other devices or systems over network 108 as well as through a direct device-to-device interface 110. For example, but not by limitation, communication system 112 communicates with a transaction security and authentication system (TSAS) and/or a transaction provider system 126. Further, in one example, communication system 112 provides a direct wireless communication interface with system 104 using any suitable protocol, such as, but not limited to, WiFi, Bluetooth, et cetera. In one example, communication system 112 utilizes a wireless data communication or exchange device to wirelessly transfer data between client device 106 and systems 104 and/or 124. For instance, client device 106 can include a near-field communication device, such as, but not limited to, a radio frequency identification (RFID) transceiver.

Client device 106 also includes one or more processors 114 and a display system 116 that includes a user interface component 118, one or more sensors 120, and can include other items 122 as well. Sensor(s) 120 are configured to detect inputs to display system 116. In one example, one or more of systems 104, 124, and 126 can include sensors to detect inputs to those systems as well.

User interface component 118 is configured to generate user interface displays 130 with user input mechanisms 132. User 102 interacts with, or actuates, the user input mechanisms 132 in order to control and manipulate client device 106. Client device 106 can include other items 134 as well.

System 104 includes a data store 128 that stores data for use within the organization that employs system 104. For example, data store 128 can include data pertaining to goods and/or services offered by a retail organization, customer information, employee information, et cetera. System 104 can also include a user interface component 135 for generating user interface displays, and/or processor(s)/server(s) 137. System 104 can include other items 139 as well. In one example, processor(s) 114 and/or processor(s)/server(s) 137 comprise a computer processor with associated memory and timing circuitry (not shown). The computer processor is a functional part of the systems within which they are located and is activated by, and facilities the functionality of, other systems, components and items in those systems.

System 104, in one example, includes an on-premise transaction system 136 that includes a transaction agent 138 and other functionality 140. For example, on-premise transaction system 136 can be deployed by an organization within a brick and mortar retail store, kiosk, or other environment. By way of example, an organization can deploy system 136 at one or more points of sale that include point of sale (POS) components. These POS components may be connected to a headquarters or back office system, for example.

For example, a POS can comprise a checkout lane within a retail store so that POS components include some or all of a cash register, a cash drawer, a bar code scanner, an RFID reader, a keyboard, a pin pad, and a credit or debit card hardware device. The POS components can also include a scale as well as other various printers and display devices. In the illustrated example, a wireless communication device, such as a near-field communication device or other wireless communication device, is configured to communicate with communication system 112 of client device 106 through interface 110.

Transaction agent 138 is configured so that user 102 can perform a value transfer transaction using a transaction instrument without the transaction instrument being physically present during the transaction. Examples of transaction instruments include, but are not limited to, a payment card (e.g., a credit card, debit card, smart card, et cetera). This type of transaction is often referred to as a card-not-present transaction since the payment card, or other transaction instrument, is not physically present during the transaction.

Transaction agent 138 is configured to interact with client device 106 to exchange transaction information securely and to request TSAS 124 to conduct a value transfer transaction for user 102 given the transaction instrument information presented by user 102. In one example, a client agent 142 runs on client device 106 and facilitates the interaction. TSAS 124 processes a transaction request received from transaction agent 138 by communicating with transaction provider system 126. By way of example, in processing card payments, an organization uses transaction provider system 126 (which may be an entity that handles value transfers for various banks, or which may be the bank itself) in conducing transactions. Transaction provider system 126 validates the payment card being used by user 102 and authorizes the transfer of funds.

Alternatively, or in addition to system 136, system 104 can include an online (e.g., network-based) transaction system 144. System 144 includes a transaction agent 146 and other functionality 148. In one example, system 144 can provide an e-commerce presence for an organization, such as an online store or marketplace presence in which user 102 can browse, select, and purchase products and/or services provided by an organization through network 108. In one example, transaction agent 146 is similar to transaction agent 138, discussed above.

It is noted that the location and functionality of systems 104, 124, and 126 can be combined and/or distributed in any of a number of ways. Some or all portions of systems 104, 124, and 126 can be local to one another, or can be remotely located. Further, one or more of systems 104, 124, and 126 can be remotely located from client device 106. For instance, some or all of systems 104, 124, and 126 can be provided as cloud based services for client device 106.

Further, systems 104, 124, and/or 126 can be part of and managed by a same organization. For example, systems 104 and 124 can be part of an on-premise deployment at a retail organization. In another example, the organization can deploy system 124 in a cloud-based environment that is used by one or more front-end transaction systems deployed by the organization. In yet another example, transaction provider system 126 may deploy and manage system 124. These, of course, are by way of example only.

The functionality of systems 104, 124, and/or 126 may be combined and/or separated in any of a variety of ways. Therefore, while FIG. 1 shows a variety of different functional blocks, it will be noted that the blocks can be consolidated so that more functionality is performed by each block, or they can be divided so that the functionality is further distributed. It should also be noted that the present discussion shows one or more data stores, including data store 128. Data store 128 can be any of a wide variety of different types. Further, the data in the data stores can be consolidated into a same data store, and can be stored in multiple additional data stores as well. Also, the data stores can be local to the environments, agents, modules, and/or components that access them, or they can be remote therefrom and accessed by those environments, agents, modules, and/or components. Similarly, some can be local while other remote.

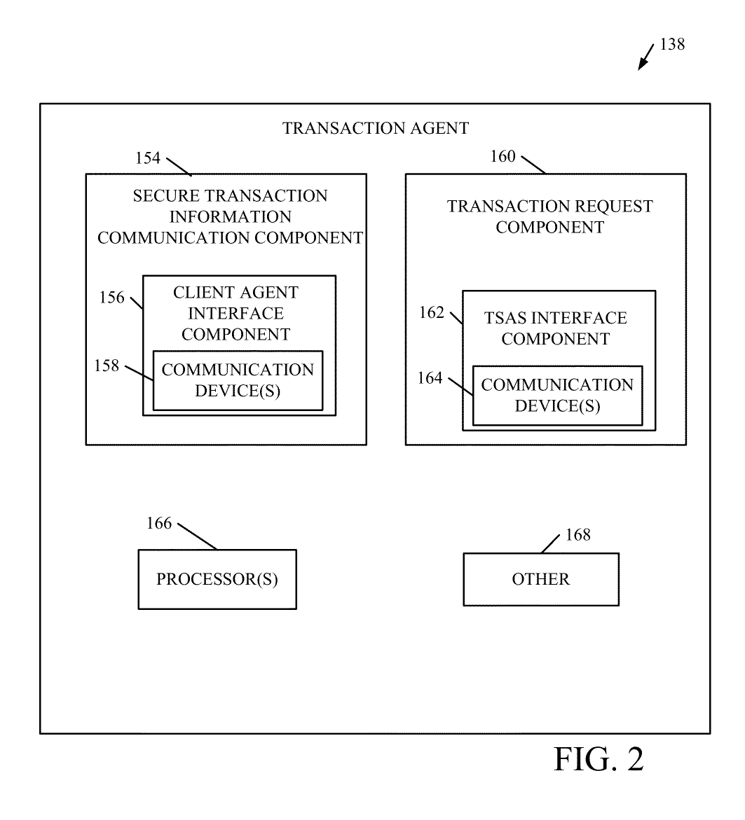

FIG. 2 is a block diagram of one example of transaction agent 138. As mentioned above, transaction agent 138 can be implemented within systems 136 and/or 144, for example. Transaction agent 138 includes a secure transaction information communication component 154 that is configured to securely communicate transaction information during a transaction being processed by system 104. Component 154 includes a client agent interface component 156 having one or more communication devices 158 configured to communicate and interact with client agent 142 on client device 106. By way of example, for a given transaction, component 154 is configured to prompt or otherwise request a set of information from user 102 in order to process the given transaction. Component 154 then receives the requested information which is used by a transaction request component 160 in facilitating the transaction. By way of example, component 160 includes a TSAS interface component 162 having one or more communication devices 164 for communicating with TSAS 124. Using communication device(s) 164, component 160 requests that TSAS 124 initiates a value transfer for the transaction between user 102 and system 104. Transaction agent 138 can include one or more processors 166, and can include other items 168 as well.

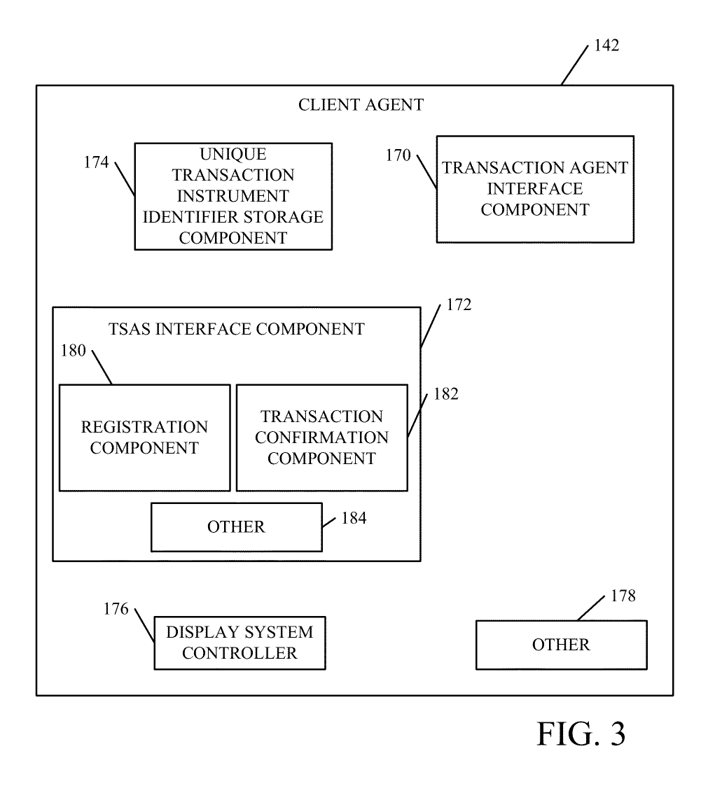

FIG. 3 is a block diagram of one example of client agent 142. Client agent 142 includes a transaction agent interface component 170 configured to interact with transaction agent 138 of system 136 and/or transaction agent 146 of system 144. Client agent 142 also includes a TSAS interface component 172 configured to interact with TSAS 124, a unique transaction instrument identifier storage component 174, a display system controller 176, and can include other items 178 as well. Component 174 is configured to store unique transaction instrument identifiers that uniquely identify transaction instruments that can be used by user 102 (or other user) during a transaction. This is discussed in further detail below. Display system controller 176 is configured to control display system 116 to render user interface displays to user 102.

Using transaction agent interface component 170 and TSAS interface component 172, client agent 142 interacts with a transaction agent (e.g., transaction agent 138 and/or transaction agent 146) and TSAS 124 to facilitate a transaction involving a value transfer from user 102 to the organization deploying system 104. For example, client agent 142 can prompt user 102 to initiate and provide information (e.g., transaction instrument information) for a value transfer process, and confirm the value transfer that is being made. This is discussed in further detail below.

Component 172 also includes a registration component 180 that is configured to register one or more transaction instruments (e.g., payment cards) of the user and contact information, such as information pertaining to client device 106, that allows TSAS 124 to contact user 102 during a transaction. Using component 174, client agent 142 stores the identifiers of the transaction instrument(s) registered with TSAS 124 in a data store 150 on client device 106. This is represented by block 152 (unique transaction instrument identifier(s) 152, shown in FIG. 1).

In the example of FIG. 3, component 172 also includes a transaction confirmation component 182 that facilitates a transaction confirmation process with user 102. Component 172 can include other items 184 as well.

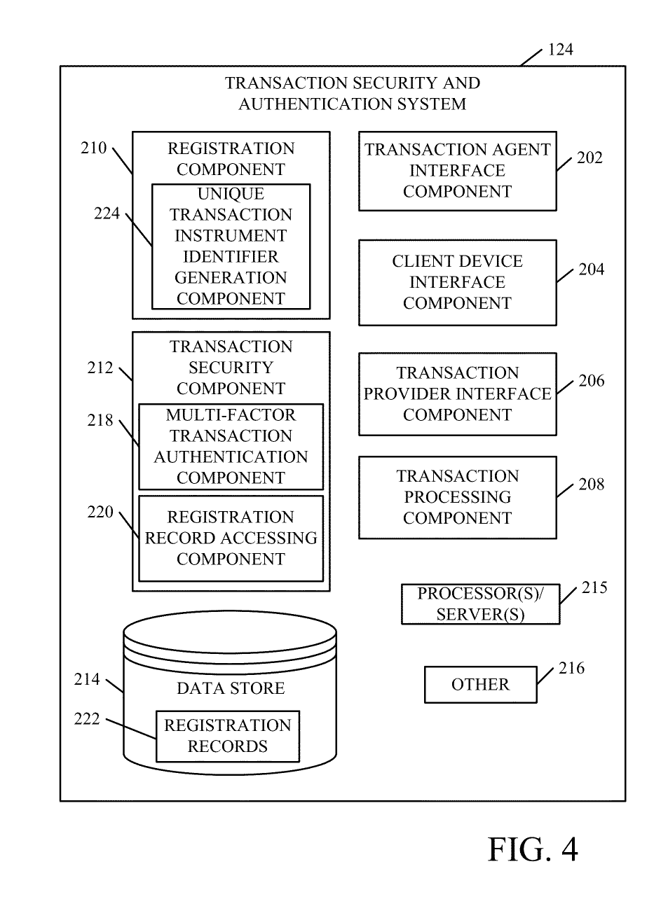

FIG. 4 is a block diagram of one example of TSAS 124. TSAS 124 includes a transaction agent interface component 202 configured to interact with a transaction agent (e.g., transaction agent 138 and/or transaction agent 146). TSAS 124 also includes a client device interface component 204 configured to communicate with client device 106. For example, where client device 106 includes a client agent 142, component 204 is configured to communicate with the client agent. In other examples, component 204 can communicate with a client device that does not include a client agent (such as in an example in which the client device is a non-smart device). For instance, component 204 can be configured to send an SMS message, email, or initiate a phone call with client device 106. A transaction provider interface component 206 is configured to communicate with transaction provider system 126.

TSAS 124 includes a transaction processing component 208, a registration component 210, and a transaction security component 212. TSAS 124 can include a data store 214, processor(s)/server(s) 215, and can include other items 216 as well. As discussed in further detail below, in one example transaction security component 212 is used to independently contact user 102 using device 106 to authenticate a transaction before processing the value transfer. This is done independent of system 104 in a manner that does not require sensitive transaction instrument information to be passed to system 104. Instead, in one example, user 102 only needs to provide a unique identifier to system 104 upon which, for a transaction request, system 104 passes the unique identifier to TSAS 124 which processes the transaction with transaction provider system 126.

Transaction processing component 206 is configured to process a transaction request received from system 104 using transaction security component 212. Component 212 includes a multi-factor transaction authentication component 218 and a registration record accessing component 220 configured to access registration records 222 in data store 214. Multi-factor transaction authentication component 218 is configured to authenticate the requested transaction with multiple factor authentication (e.g., two-factor authentication et cetera).

In one example, TSAS 124 comprises a service through which users, such as user 102, registers their respective transaction instruments and client devices. Registration component 210 facilitates this registration through client device interface component 204, which communicates with client agent 142 (or other components) on client device 106. In one example, registration component 210 includes a unique transaction instrument identifier generation component 224 that is configured to generate unique identifiers for transaction instruments registered with TSAS 124.

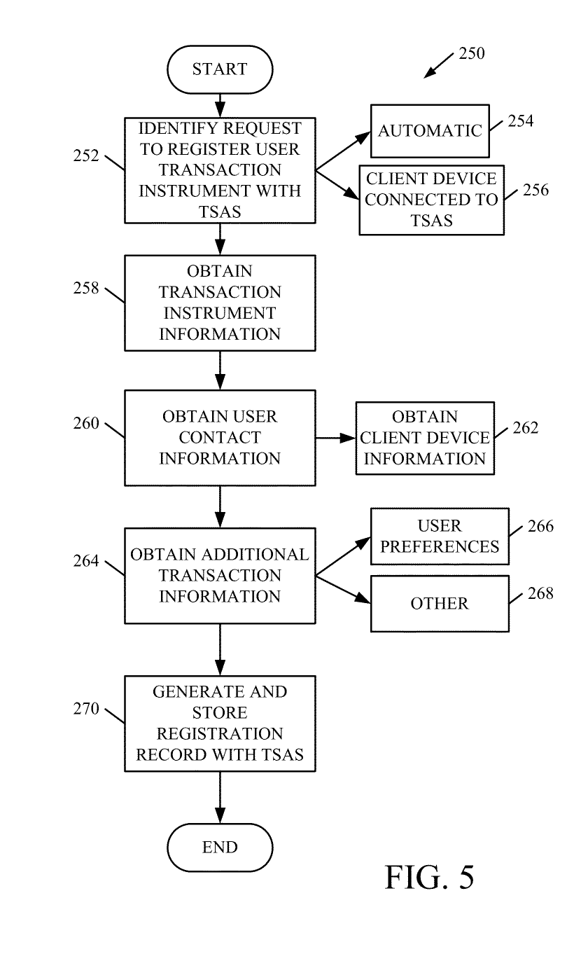

For sake of further illustration, FIG. 5 is a flow diagram of one example of a method 250 for registration of a user client device and one or more user transaction instruments (e.g., payment cards). For the sake of illustration, but not by limitation, method 250 will be described in the context of TSAS 124 of architecture 100.

At block 252, a request to register a user transaction instrument with TSAS 124 is received or otherwise identified. For example, a registration request can be automatically sent to TSAS 124 when a new transaction instrument is issued to a user by transaction provider system 126. This is represented by block 254. In another example, user 102 can connect to TSAS 124 using client device 106. This is represented by block 256. In this example, client device 106 is used to log into TSAS 124 through network 108 using an encrypted relationship for communication between client device 106 and TSAS 124.

At block 258, transaction instrument information is obtained. This can include receiving an account numbers financial institution or provider information, and/or user information for user 102. In the illustrated example, the information obtained at block 258 comprises enough information to allow TSAS 124 to process a value transfer using the transfer instrument with transaction provider system 126. In the case of a credit card, for example, the information obtained at block 258 includes, but is not limited to, a credit card account number, expiration date, security code (e.g., CSC or CSV), financial institution information, et cetera.

At block 260, user contact information is obtained. In the illustrated example, the user contact information obtained at block 260 comprises enough information to allow TSAS 124 to contact user 102 on client device 106 to authenticate a transaction that user 102 (or other user associated with user 102) is making with system 104.

For example, client device information can be obtained at block 262. For instance, where client device 106 comprises a mobile phone, the client device information can include a phone number that allows TSAS 124 to initiate a phone call or send an electronic message (e.g., SMS, et cetera) to the mobile phone. Thus, in one example in which client device 106 does not include a client agent 142 (for example, if client device 106 is a non-smart device such as a feature phone), the communications between client device 106 and TSAS 124 can be performed using other functionality supported by client device 106, such as, but not limited to, sending and receiving SMS or voice messages.

In another example, the information at block 262 can include an electronic serial number (ESN), IP address, or other information associated with client device 106 that allows TSAS 124 to communicate with client agent 142 running on client device 106.

In another example, the information obtained at block 260 is not specific to client device 106. For instance, an email address of the user can be provided at block 260. User 102 can utilize a browser, for example, on client device 106 to access the user's email account to respond to an email sent by TSAS 124 during a transaction authentication process.

Also, it is noted that the information obtained at block 260 can comprise information for a plurality of different communication modalities and channels. For example, for one transaction instrument, the user can provide a phone number for the user's mobile phone and the address of the user's tablet computer so that TSAS 124 uses both devices to contact the user when authenticating a transaction.

At block 264, additional transaction information can be obtained. For example, user preferences can be obtained that define how the user wants the transactions to be authenticated by TSAS 124. This is represented at block 266. In one example, the user can specify an order flow of authentication steps that define which devices should be used to contact user 102 and an order in which those devices are used. In another example, the user can pick a modality for the communication during the authentication. For example, one user may prefer to receive SMS messages while another user may prefer to receive a phone call. Other information can be obtained as well. This is represented at block 268. At block 270, a registration record is generated and stored with TSAS 124. As illustrated in the example of FIG. 4, the registration record can be stored in data store 214.

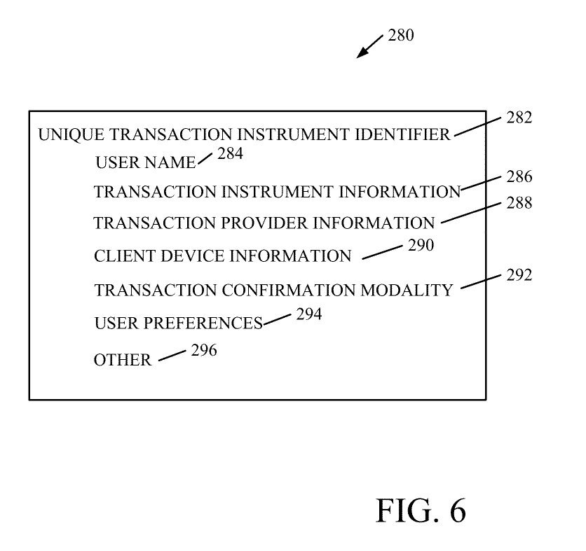

FIG. 6 illustrates one example of a registration record 280. Registration record 280 includes a plurality of fields that store various information for a given transaction instrument that a user has registered with TSAS 124. Record 280 can be stored in any suitable data structure and in any suitable format. For example, each record 280 can comprise an entry or row in a database table. This, of course, is by way of example only.

As shown in FIG. 6, registration record 280 includes a unique transaction instrument identifier field 282 that stores the unique identifier for the transaction instrument. In one example, unique identifier in field 282 is arbitrarily generated by TSAS 124 when the transaction instrument is registered. In another example, the identifier in field 282 can be based, at least in part, on the transaction instrument. For instance, the identifier in field 282 can include a portion of, or be based on, an account number of the transaction instrument. In any case, in the example of FIG. 6, the identifier in field 282 allows TSAS 124 to identify the transaction instrument being used by user 102 during a transaction with system 104.

As discussed in further detail below, this advantageously allows user 102 to perform a transaction with system 104 without having to provide the actual transaction instrument to system 104 during the transaction. This is discussed in further detail below.

Registration record 280 includes a user name field 284 that identifies the user, a transaction instrument information field 286 that includes information for the transaction instrument, and a transaction provider information field 288. By way of example, field 286 stores the information for the transaction instrument that is required by TSAS 124 to process a funds transfer with transaction provider system 126 using the transaction instrument. In the case of a checking account, for example, this can include an account number and routing number. In the case of a credit card, for example, this can include a card number, expiration date, CSV, et cetera. The information field 288 can include a name, address and/or other information for the transaction provider system 126 that will process the transaction using the transaction instrument.

Record 280 can also include a client device information field 290 that stores information for the client device, a transaction confirmation modality field 292, a user preferences field 294, and it can include other fields 296 as well. Transaction confirmation modality field 292 identifies a modality for confirming the transaction with user 102 and user preferences field 294 stores user preferences for the confirmation.

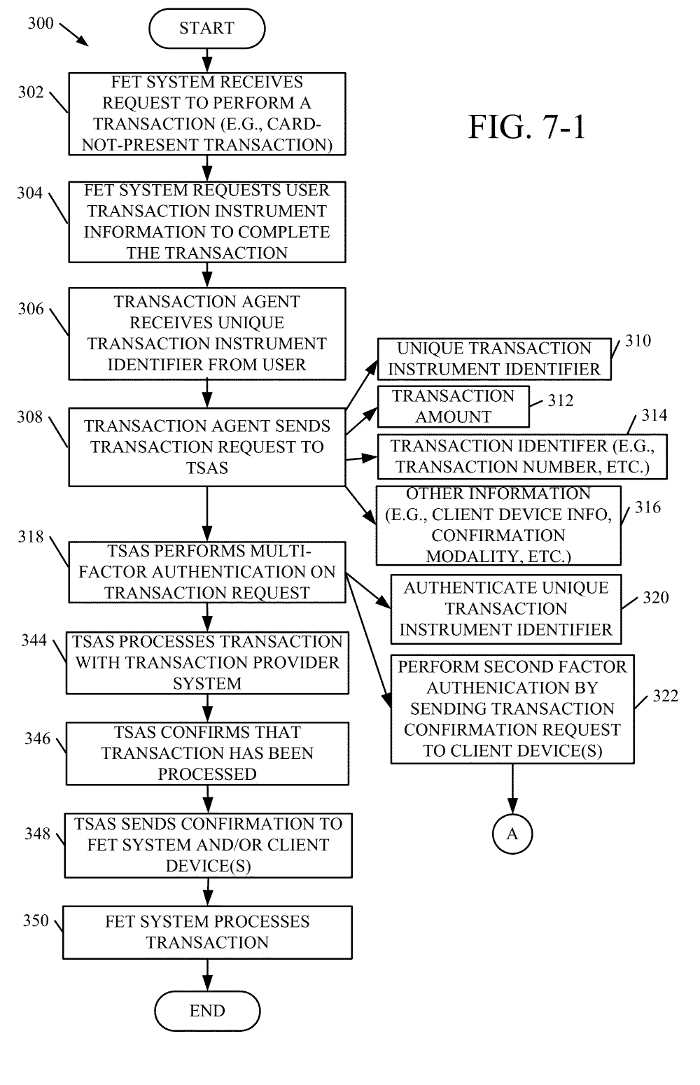

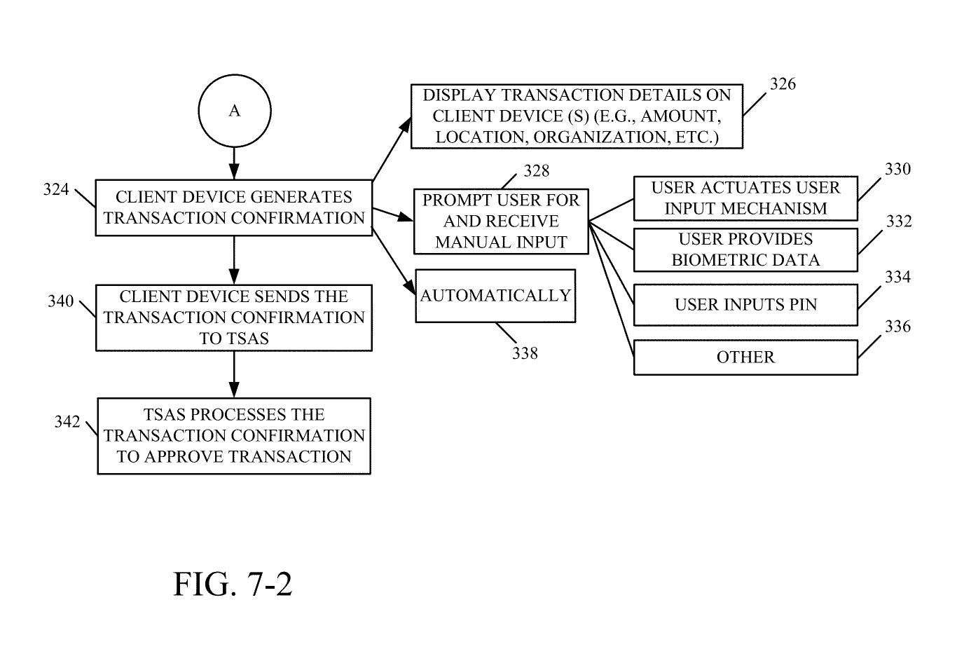

FIGS. 7-1 and 7-2 (collectively referred to as FIG. 7) illustrate a flow diagram of one example of a method 300 for facilitating a transaction using a transaction instrument registered with a transaction security and authentication system. For sake of illustration, but not by limitation, method 300 will be described in the context of architecture 100 that uses TSAS 124 to authenticate a transaction between user 102 and system 104.

At block 302, FET system 104 receives a request to perform a transaction. In the illustrated example, the transaction involves a card-not-present payment, such as in a mobile on-premise transaction or an online transaction. For instance, in a mobile on-premise transaction a user approaches a POS terminal and initiates a transaction using their mobile phone that stores a unique transaction instrument identifier 152. In an online transaction example, such as an e-commerce transaction, a user browses a website of a retail organization and selects one or more products to purchase and then initiates a checkout process. In other words, at block 302, user 102 may be physically present within a brick and mortar retail store of an organization, or maybe using an online marketplace or store of the organization. Other scenarios are possible as well.

At block 304, system 104 requests user transaction instrument information to complete the transaction. For example, system 104 can prompt or otherwise request the user to provide the unique transaction instrument identifier 152 for the transaction instrument that user 102 wants to use for the transaction. The user can be prompted manually (e.g., by an employee at a POS) and/or automatically by system 104 (e.g., by an electronic device at a POS or through a web browser).

At block 306, a transaction agent (e.g., transaction agent 138 and/or 146) receives the unique transaction instrument identifier from user 102. In one example, the user 102 can manually provide this information to system 104. For example, the user can verbally communicate this information to an employee user of system 104 or manually enter this information into an input device of system 104.

In another example, block 306 can be performed automatically or semi-automatically. For instance, user 102 uses client device 106 to wirelessly communicate the unique transaction instrument identifier 152 to a corresponding wireless input device of system 104. Also, the user can provide additional information. For instance, user 102 can identify how the user wishes to confirm the transaction with TSAS 124. In one example, user 102 can identify the device that the user wants to be contacted with and/or a modality for the confirmation request.

At block 308, the transaction agent sends a transaction request to TSAS 124. The request includes the unique transaction instrument identifier provided by user 102. This is represented by block 310. In one example, the unique transaction instrument identifier sent to TSAS 124 comprises an encrypted token. Also, the transaction request can include a transaction amount. This is represented by block 312. Alternatively, or in addition, the transaction request can include a transaction identifier (e.g., a transaction number that identifies the transaction for which the request is being sent). This is represented by block 314. Other information such as client device information, confirmation modality, et cetera can also be sent with the transaction request. This is represented by block 316.

At block 318, TSAS 124 performs multi-factor authentication to approve the transaction request. In the illustrated example, this includes authenticating the unique transaction instrument identifier. This is represented by block 320. In one example, TSAS 124 determines that the unique transaction instrument identifier provided with the transaction request comprises a valid identifier registered in data store 214.

At block 322, TSAS 124 performs second-factor authentication by sending a transaction confirmation request to user 102. For instance, TSAS 124 uses client device interface component 204 to send a communication to client device 106. This can take any of a variety of different communication forms. For example, TSAS 124 can send an electronic message (e.g., email, text message, et cetera), initiate a voice call with user 102, or communicate via client agent 142 on client device 106. Client agent 142 can comprise an application running on client device 106 that presents user interfaces to user 102 that prompts user 102 for confirmation input.

At block 324, the client device generates a transaction confirmation. In one example, client agent 142 utilizes display system controller 176 to control display system 116 to present user interface displays 130 with transaction details. The transaction details can include, but are not limited, an amount of the transaction, a location of the transaction, the organization with which the transaction is taking place, et cetera. This is represented by block 326.

At block 328, user 102 is prompted for a manual input the confirms the transaction. In one example, user 102 responds to messages from an automated system. In another example, user 102 can communicate with person, via a phone call or instant messaging service, that authenticates user 102 for TSAS 124.

In the illustrated example, client device 106 prompts user 102 for input, such as by actuating a user input mechanism (e.g., an accept button). This is represented by block 330. In another example, the user can provide biometric data, such as using a fingerprint or retina scanner on client device 106. This is represented by block 332. In another example, the user can input a personal identification number (PIN) through client device 106. This is represented by block 334. The confirmation can be received from user 102 in other ways as well. This is represented by block 336.

Alternatively, or in addition, the transaction confirmation can be automatically generated by client device 106. This is represented by block 338. For example, client agent 142 can be configured to automatically confirm a transaction in accordance with a set of pre-defined parameters that ensure appropriate authentication of the transaction. For instance, client agent 142 can determine a location of the client device in relation to the location and organization provided with the transaction request. This ensures that the client device is physically present at the location from which the transaction request originated. This, of course, is by way of example only. Other ways of automatically confirming the transaction requests are possible.

At block 340, the client device sends the transaction confirmation to TSAS 124. For example, where user 102 is prompted via a phone call, user 102 can provide a voice input or key press input upon which client device 106 sends a signal to TSAS 124 indicating that user 102 has confirmed the transaction. In another example, at block 340, user 102 can respond with a reply email, SMS message, voice message, or any other suitable communication protocol supported by client device 106.

At block 342, TSAS 124 processes the transaction confirmation to approve the transaction. Based on approving the transaction, at block 344 TSAS 124 processes the transaction with transaction provider system 126. TSAS 124 confirms that the transaction has been processed at block 346. Then, TSAS 124 can send a confirmation that the transaction has been processed to FET system 104 and/or client device 106. This is represented by block 348. The transaction can be finalized or otherwise processed by FET system 104 at block 350.

It can thus be seen that the present description provides significant technical advantages. For sake of illustration, but not by limitation, organizations such as retail establishments are often required to support a variety of different value transfer methods. Many retail establishments are able to accept cash as a payment option, but they can also accept non-cash payment instruments with which a user, such as a consumer, transfers funds between accounts at banks or other financial institutions. Some examples of payment instruments include, but are not limited to, charge cards, credit cards, and debit cards. Further, there are a variety of different types of payment cards. Some cards include magnetic stripes where information is read by a magnetic stripe reader at a point of sale. Other payment cards examples include smart cards or integrated circuit cards (i.e., chip cards) which include an embedded integrated circuit chip that interacts with a chip card reader at the point of sale. These of course, are examples only.

Computing systems used by merchants or other retail organizations facilitate mobile or e-commerce transactions, or other transactions in which the cardholder does not or cannot physically present the card for the merchant's visual examination. These transactions are referred to as “card-not-present” transactions. Some examples of card-not-present transactions include, but are not limited to, payments made by mail-order transactions by mail or fax, or over the phone or internet (e.g., a user accesses a merchant's e-commerce presence, such as an online store or marketplace, to select and purchase goods or services). Another example of a card-not-present transaction includes a mobile payment in which a user uses their mobile device to transfer stored payment card information to the merchant's system, but the user does not physically possess the payment card or otherwise cannot physically present the payment card to the merchant.

Industry standards, such as the Payment Card Industry Data Security Standard (PCI DSS), apply to entities involved in payment card processing, including merchants, processors, acquirers, issuers, and service providers, as well as all other entities that store, process or transmit payment card holder data (CHD). These standards often apply to e-commerce and mobile payments as they accept payment card holder data for the purpose of charging to the payment card for products or services. Further, payment card transactions often include an interchange fee paid between banks or other financial institutions for the acceptance of the card-based transactions. By way of example, the interchange fee is usually a fee that a merchant's bank pays a customer's bank. The card-issuing bank in the transaction deducts the interchange fee from the amount it pays the acquiring bank that handles the transaction for the merchant. The acquiring bank then pays the merchant the amount of the transaction minus both the interchange fee and, often, an additional fee referred to as a discount rate. These interchange rates and fees are much higher for card-not-present transactions than card-present transactions.

Further yet, the lack of presence of the payment card for the transaction increases the possibility of fraudulent activity and other card holder data card security issues. One way to address these limitations is payment card tokenization. However, payment card tokenization does not eliminate the need of the payment solution to accept card numbers entered by the consumer before the number can be tokenized. Another way to address these issues is end-to-end encryption. However, end-to-end encryption requires additional peripherals, such as an encrypted audio jack MSR, or an expensive EMV-capable terminal, and does not allow for “non-smart” phones to make the payment. Also, these solutions do not avoid the expensive card-not-present interchanges rates.

Architecture 100 provides an electronic transaction framework that facilitates secure transfer of user and transaction instrument information in mobile and online transactions, or other card-not-present transactions in which the transaction is made without the card holder physically presenting the transaction instrument for visual examination. In addition to increasing security in these transactions, architecture 100 allows these types of transactions to be settled with transaction interchange rates and fees that are close to card-present transactions.

Architecture 100 reduces the processing burden on an organization by reducing the need to securely pass around transaction instrument information such as payment card information and payment card tokens. The user does not need to send payment card information to the organization during the transaction. Rather, the transaction is independently and separately authenticated with the user using a transaction security and authentication system.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, et cetera. They can also be actuated in a wide variety of different ways. For instance, they can be actuated using a point and click device (such as a track ball or mouse). They can be actuated using hardware buttons, switches, a joystick or keyboard, thumb switches or thumb pads, et cetera. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

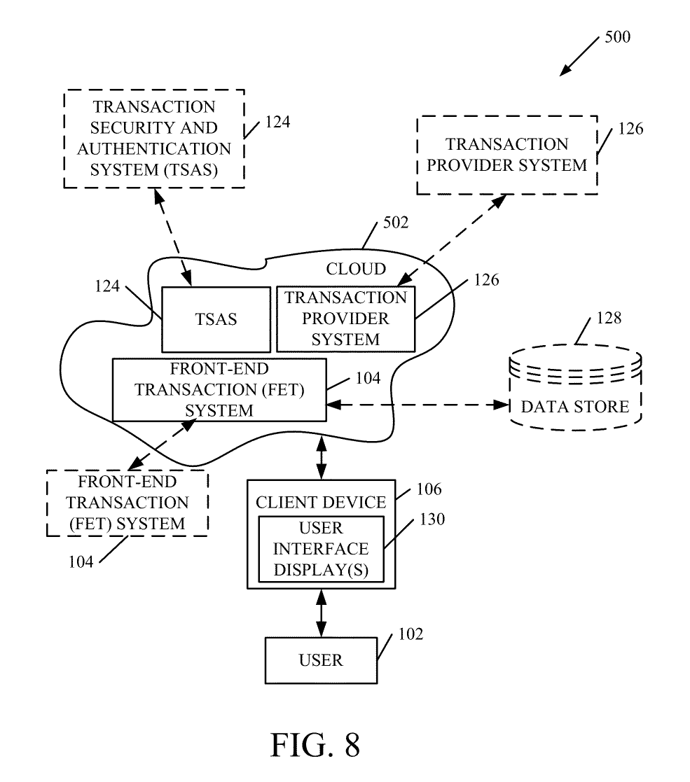

FIG. 8 is a block diagram of a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, et cetera.

In the embodiment shown in FIG. 8, some items are similar to those shown in FIG. 1 and they are similarly numbered. FIG. 8 specifically shows that some or all components of architecture 100 are located in cloud 502 (which can be public, private, or a combination where portions are public while others are private). Therefore, user 102 uses client device 106 to access those components through cloud 502.

FIG. 8 also depicts another embodiment of a cloud architecture. FIG. 8 shows that it is also contemplated that some elements of architecture 100 are disposed in cloud 502 while others are not. In one example, data store 128 can be disposed outside of cloud 502, and accessed through cloud 502. In another example, front-end transaction system 104 can be disposed outside of cloud 502, and accessed through cloud 502. In another example, transaction security and authentication system 124 can be disposed outside of cloud 502, and accessed through cloud 502. In another example, transaction provider system 126 can be disposed outside of cloud 502, and accessed through cloud 502. Regardless of where they are located, the elements of architecture 100 can be accessed directly by device 106, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, et cetera.

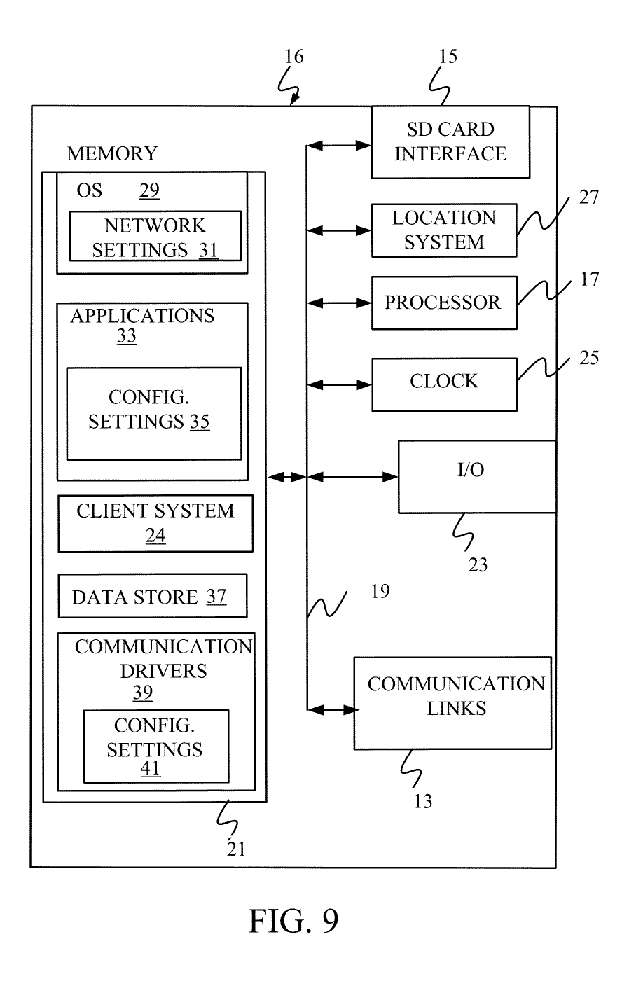

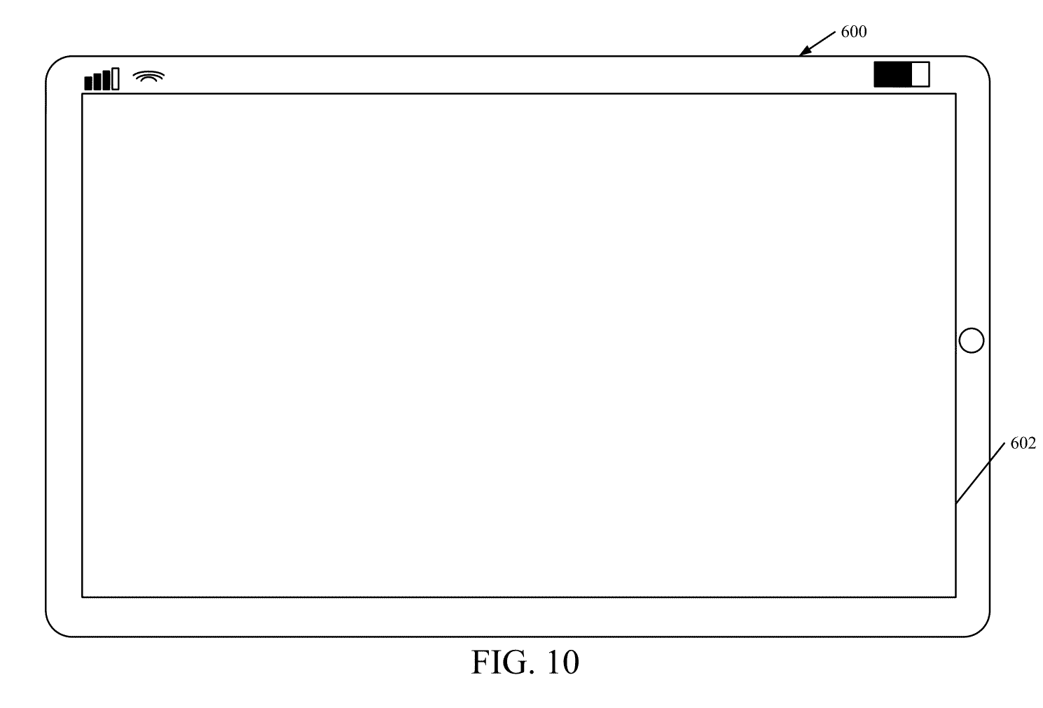

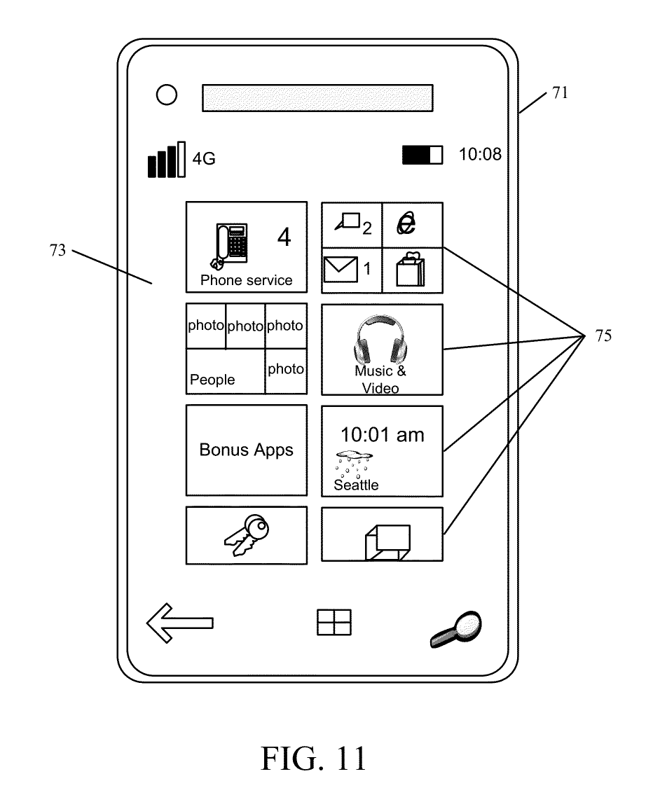

FIG. 9 is a simplified block diagram of one illustrative embodiment of a handheld or mobile computing device that can be used as a user's or client's hand held device 16, in which the present system (or parts of it) can be deployed. FIGS. 10-11 are examples of handheld or mobile devices.

FIG. 9 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Items in data store 128, for example, can reside in memory 21. Similarly, device 16 can have a client system 24 which can run various business applications. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 10 shows one embodiment in which device 16 is a tablet computer 600. In FIG. 10, computer 600 is shown with user interface display displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used, as well. Device 16 can be a feature phone, smart phone or mobile phone. The phone includes a set of keypads for dialing phone numbers, a display capable of displaying images including application images, icons, web pages, photographs, and video, and control buttons for selecting items shown on the display. The phone includes an antenna for receiving cellular phone signals such as General Packet Radio Service (GPRS) and 1Xrtt, and Short Message Service (SMS) signals. In some embodiments, phone also includes a Secure Digital (SD) card slot that accepts a SD card.

The mobile device can be personal digital assistant (PDA) or a multimedia player or a tablet computing device, et cetera (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA also includes a number of user input keys or buttons which allow the user to scroll through menu options or other display options which are displayed on the display, and allow the user to change applications or select user input functions, without contacting the display. Although not shown, The PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device also includes a SD card slot that accepts a SD card.

FIG. 11 shows that the phone is a smart phone 71. Smart phone 71 has a touch sensitive display 73 that displays icons or tiles or other user input mechanisms 75. Mechanisms 75 can be used by a user to run applications, make calls, perform data transfer operations, et cetera. In general, smart phone 71 is built on a mobile operating system and offers more advanced computing capability and connectivity than a feature phone.

Note that other forms of the devices 16 are possible.

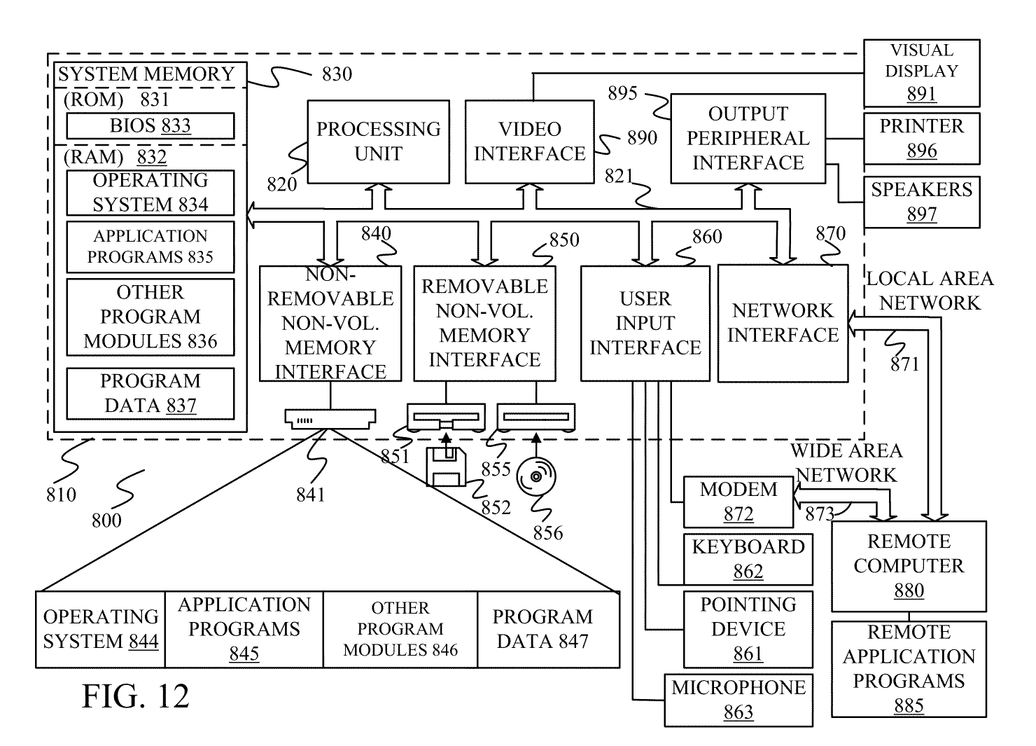

FIG. 12 is one embodiment of a computing environment in which architecture 100, or parts of it, (for example) can be deployed. With reference to FIG. 12, an exemplary system for implementing some embodiments includes a general-purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), et cetera.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a transaction security and authentication system comprises a front-end transaction system interface component configured to communicate with a front-end transaction system that performs a transaction with a user, a client device interface component configured to communicate with a client device of the user, and a transaction security component configured to receive a transaction request, for the transaction, from the front-end transaction system, the transaction request including a unique transaction instrument identifier, and authenticate the transaction by sending a transaction confirmation request to the client device based on the unique transaction instrument identifier and receiving a transaction confirmation from the client device.

Example 2 is the transaction security and authentication system of any or all previous examples, wherein the transaction security component is configured to identify, based on the unique transaction instrument identifier, the client device of the user and a transaction instrument associated with the user.

Example 3 is the transaction security and authentication system of any or all previous examples, wherein the unique transaction instrument identifier comprises an encrypted token.

Example 4 is the transaction security and authentication system of any or all previous examples, and further comprising a registration component configured to generate a registration record that associates the unique transaction instrument identifier to the transaction instrument and to the user, and store the registration record in a data store.

Example 5 is the transaction security and authentication system of any or all previous examples, wherein the registration component is configured to receive a registration request for the transaction instrument associated with the user and to generate the registration record to associate the client device of the user with the unique transaction instrument identifier.

Example 6 is the transaction security and authentication system of any or all previous examples, and further comprising a transaction processing component configured to process the authenticated transaction.

Example 7 is the transaction security and authentication system of any or all previous examples, wherein the unique transaction instrument identifier is generated by the transaction security and authentication system.

Example 8 is the transaction security and authentication system of any or all previous examples, and further comprising a transaction provider system interface component configured to communicate with a transaction provider system, wherein the transaction processing component processes the authenticated transaction by transmitting information for the authenticated transaction to the transaction provider system through the transaction provider system interface component.

Example 9 is the transaction security and authentication system of any or all previous examples, wherein the unique transaction instrument identifier is based on an identifier assigned to the transaction instrument by the transaction provider system.

Example 10 is the transaction security and authentication system of any or all previous examples, wherein the transaction comprises a value transfer and the transaction request identifies an amount.

Example 11 is the transaction security and authentication system of any or all previous examples, wherein the transaction confirmation request prompts the user for a user input on the client device, and the transaction confirmation is sent by the client device in response to the user input.

Example 12 is a computer-implemented method comprising communicating, to a front-end transaction system, a unique transaction instrument identifier for a transaction between a user and the front-end transaction system, receiving, at a client device, a transaction confirmation request from a transaction authentication system that is separate from the front-end transaction system, prompting, using the client device, the user for a user input to confirm the transaction, detecting a user input on the client device that confirms the transaction, and sending a transaction confirmation to the transaction authentication system.

Example 13 is the computer-implemented method of any or all previous examples, wherein communicating comprises electronically transmitting the unique transaction instrument identifier from the client device to the front-end transaction system.

Example 14 is the computer-implemented method of any or all previous examples, wherein the unique transaction instrument identifier is electronically transmitted using corresponding wireless data communication devices on the client device and the front-end trans action system.

Example 15 is the computer-implemented method of any or all previous examples, wherein prompting comprises generating a transaction confirmation user interface display that displays transactions details for the transaction.

Example 16 is a mobile device comprising a data store that stores a unique transaction instrument identifier, a communication system configured to transmit, to a transaction system, the unique transaction instrument identifier for a transaction between a user and the transaction system, and to receive, from a transaction authentication system, a transaction confirmation request that requests user confirmation of the transaction, and a display system configured to generate a transaction confirmation user interface display, with a user input mechanism, based on the transaction confirmation request and to detect a user interaction with the user input mechanism that provides the user confirmation of the transaction, wherein the communication system is configured to transmit a confirmation to the transaction authentication system in response to the user confirmation.

Example 17 is the mobile device of any or all previous examples, wherein the transaction system comprises a front-end transaction system that is separate from the transaction authentication system.

Example 18 is the mobile device of any or all previous examples, and further comprising a client agent that is configured to receive the transaction confirmation request and to control the display system to generate the transaction confirmation user interface display.

Example 19 is the mobile device of any or all previous examples, wherein the transaction confirmation user interface display displays transaction details for the transaction.

Example 20 is the mobile device of any or all previous examples, wherein the communication system comprises a wireless data communication device configured to transmit the unique transaction instrument identifier to a corresponding wireless data communication device in the transaction system.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What is claimed is:

1. A transaction security and authentication system comprising:
a front-end transaction system interface component configured to communicate with a front-end transaction system that performs a transaction with a user;
a client device interface component configured to communicate with a client device of the user; and
a transaction security component configured to:
receive a transaction request, for the transaction, from the front-end transaction system, the transaction request including a unique transaction instrument identifier; and
authenticate the transaction by sending a transaction confirmation request to the client device based on the unique transaction instrument identifier and receiving a transaction confirmation from the client device.

2. The transaction security and authentication system of claim 1, wherein the transaction security component is configured to identify, based on the unique transaction instrument identifier, the client device of the user and a transaction instrument associated with the user.

3. The transaction security and authentication system of claim 2, wherein the unique transaction instrument identifier comprises an encrypted token.

4. The transaction security and authentication system of claim 1, and further comprising:
a registration component configured to generate a registration record that associates the unique transaction instrument identifier to the transaction instrument and to the user, and store the registration record in a data store.

5. The transaction security and authentication system of claim 4, wherein the registration component is configured to receive a registration request for the transaction instrument associated with the user and to generate the registration record to associate the client device of the user with the unique transaction instrument identifier.

6. The transaction security and authentication system of claim 1, and further comprising:
a transaction processing component configured to process the authenticated transaction.

7. The transaction security and authentication system of claim 6, wherein the unique transaction instrument identifier is generated by the transaction security and authentication system.

8. The transaction security and authentication system of claim 6, and further comprising:
a transaction provider system interface component configured to communicate with a transaction provider system, wherein the transaction processing component processes the authenticated transaction by transmitting information for the authenticated transaction to the transaction provider system through the transaction provider system interface component.

9. The transaction security and authentication system of claim 8, wherein the unique transaction instrument identifier is based on an identifier assigned to the transaction instrument by the transaction provider system.

10. The transaction security and authentication system of claim 1, wherein the transaction comprises a value transfer and the transaction request identifies an amount.

11. The transaction security and authentication system of claim 1, wherein the transaction confirmation request prompts the user for a user input on the client device, and the transaction confirmation is sent by the client device in response to the user input.

12. A computer-implemented method comprising:
communicating, to a front-end transaction system, a unique transaction instrument identifier for a transaction between a user and the front-end transaction system;
receiving, at a client device, a transaction confirmation request from a transaction authentication system that is separate from the front-end transaction system;
prompting, using the client device, the user for a user input to confirm the transaction;
detecting a user input on the client device that confirms the transaction; and
sending a transaction confirmation to the transaction authentication system.

13. The computer-implemented method of claim 12, wherein communicating comprises:
electronically transmitting the unique transaction instrument identifier from the client device to the front-end transaction system.

14. The computer-implemented method of claim 13, wherein the unique transaction instrument identifier is electronically transmitted using corresponding wireless data communication devices on the client device and the front-end transaction system.

15. The computer-implemented method of claim 12, wherein prompting comprises generating a transaction confirmation user interface display that displays transactions details for the transaction.

16. A mobile device comprising:
a data store that stores a unique transaction instrument identifier;
a communication system configured to transmit, to a transaction system, the unique transaction instrument identifier for a transaction between a user and the transaction system, and to receive, from a transaction authentication system, a transaction confirmation request that requests user confirmation of the transaction; and
a display system configured to generate a transaction confirmation user interface display, with a user input mechanism, based on the transaction confirmation request and to detect a user interaction with the user input mechanism that provides the user confirmation of the transaction, wherein the communication system is configured to transmit a confirmation to the transaction authentication system in response to the user confirmation.

17. The mobile device of claim 16, wherein the transaction system comprises a front-end transaction system that is separate from the transaction authentication system.

18. The mobile device of claim 16, and further comprising:
a client agent that is configured to receive the transaction confirmation request and to control the display system to generate the transaction confirmation user interface display.

19. The mobile device of claim 16, wherein the transaction confirmation user interface display displays transaction details for the transaction.

20. The mobile device of claim 16, wherein the communication system comprises a wireless data communication device configured to transmit the unique transaction instrument identifier to a corresponding wireless data communication device in the transaction system.
